(19) United States
(12) Patent Application Publication
(10) Pub. No.: US 2015/0279309 A1
(43) Pub. Date: Oct. 1, 2015

(54) DRAWING SYSTEM, DRAWING METHOD AND ARTICLE MANUFACTURING METHOD

(71) Applicant: CANON KABUSHIKI KAISHA, Tokyo (JP)

(72) Inventor: Chiaki Sato, Utsunomiya-shi (JP)

(21) Appl. No.: 14/670,260

(22) Filed: Mar. 26, 2015

(30) Foreign Application Priority Data
Mar. 28, 2014 (JP) 2014-069414

(51) Int. Cl. G09G 5/00; G06T 7/00; G06T 1/20; G09G 5/10; G06T 11/20; G06T 5/00; G09G 5/18

(52) U.S. Cl. CPC G09G 5/003; G06T 5/00; G06T 7/0012; G09G 5/18; G09G 5/10; G06T 11/203; G06T 1/20; G09G 2370/022

(57) ABSTRACT

At least one drawing system includes drawing apparatuses each configured to radiate a beam onto a substrate to draw a pattern, and a transmitting unit configured to transmit image data regarding the pattern to the drawing apparatuses. In at least one embodiment, the transmitting unit is configured to transmit identical image data to a plurality of drawing apparatuses included in the drawing apparatuses, and at least one drawing apparatus of the plurality of drawing apparatuses is configured to use the identical image data and correction image data for correcting a partial image of the identical image data to correct the partial image.

### BACKGROUND OF THE INVENTION

1. Field of the Invention

The present inventions relate to at least one drawing system, at least one drawing method and at least one article manufacturing method.

2. Description of the Related Art

Lower throughputs are known as a problem of a drawing apparatus which radiates a beam onto a substrate to draw a pattern. Japanese Patent Laid-Open No. 62-57215 discloses an apparatus configuration which uses two electron beam drawing apparatuses to draw one pattern to be formed. It is further disclosed that identical pattern data are transmitted from one memory to two electron-beam drawing apparatus, and a data correction control unit within each of the electron-beam drawing apparatuses performs a correction such as multiplying the pattern data by a correction parameter unique to the apparatus or a distortion parameter unique to a chip therein.

However, the method disclosed in Japanese Patent Laid-Open No. 62-57215 which performs a correction process on entire data of a pattern by multiplying a parameter may leave parts of a complicated pattern to be drawn uncorrected, which may cause large variations in drawing results between apparatuses.

### SUMMARY OF THE INVENTION

The present inventions provide at least one drawing system which may perform a local correction process on data of a pattern represented by an image such as pixels.

According to at least one aspect of the present inventions, there is provided at least one drawing system including drawing apparatuses each configured to radiate a beam onto a substrate to draw a pattern, and a transmitting unit configured to transmit image data regarding the pattern to the drawing apparatuses, wherein the transmitting unit is configured to transmit identical image data to a plurality of drawing apparatuses included in the drawing apparatuses; and at least one drawing apparatus of the plurality of drawing apparatuses is configured to use the identical image data and correction image data for correcting a partial image of the identical image data to correct the partial image.

According to other aspects of the present inventions, other apparatuses, systems, drawing methods and article manufacturing methods are discussed herein. Further features of the present inventions will become apparent from the following description of exemplary embodiments with reference to the attached drawings.

### BRIEF DESCRIPTION OF THE DRAWINGS

FIGS. 1A and 1B are schematic diagrams that illustrate a drawing system according to a first exemplary embodiment.

FIG. 2 is a diagram that illustrates the presence/absence of correction data.

FIG. 3 is a flowchart that illustrates a flow up to transmission of drawing data.

FIG. 4 is a diagram that illustrates common data.

FIGS. 5A to 5C are simulation diagrams of drawing results with common data.

FIGS. 6A and 6B are diagrams that illustrate correction pattern data and correction data.

FIG. 7 is a diagram that illustrates job details to be performed by a processing unit.

### DESCRIPTION OF THE EMBODIMENTS

The present inventions relate to at least one drawing system having a drawing apparatus group (drawing apparatuses) which uses a beam such as an electron beam, an ion beam, and a laser beam to form a pattern on a substrate. According to an exemplary embodiment, at least one drawing system may have ten drawing apparatuses as the drawing apparatus group each of which uses an electron beam to draw a pattern.

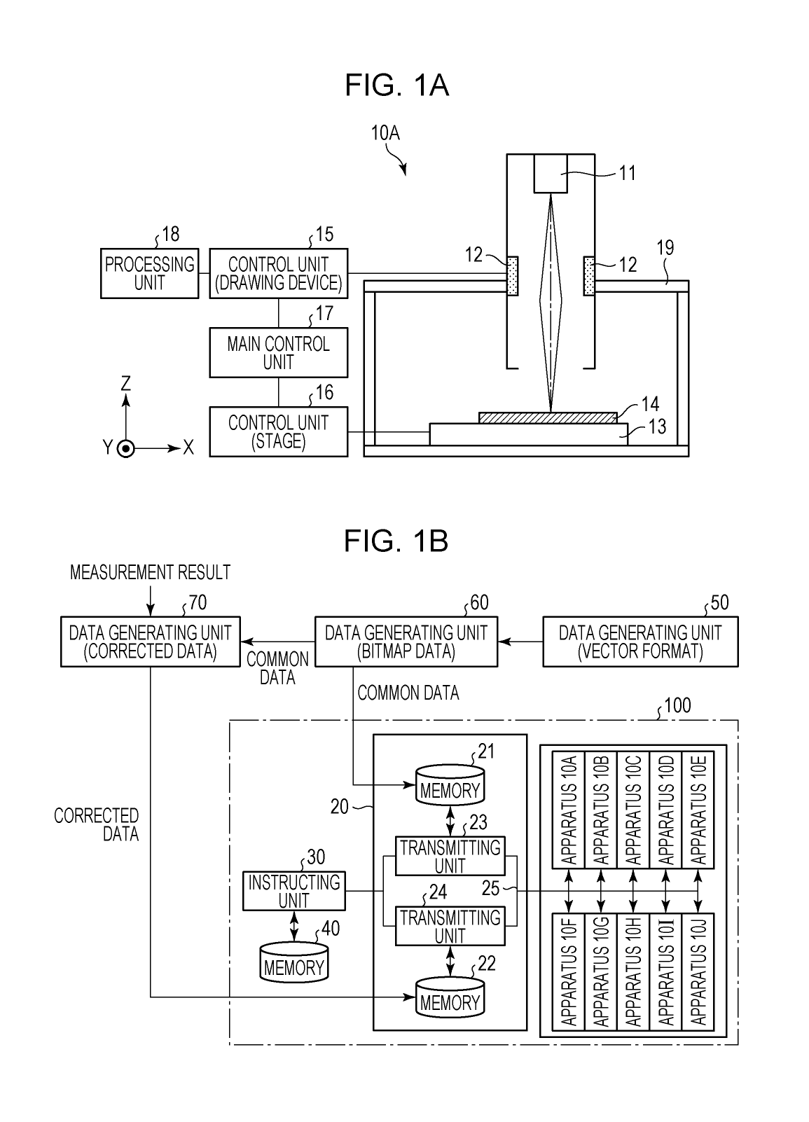

FIGS. 1A and 1B illustrate a drawing system 100 which performs drawing in order to acquire drawing results of one pattern from ten drawing apparatuses 10A to 10J according to a first exemplary embodiment. FIG. 1A illustrates a configuration of the drawing apparatus 10A which is one of the ten drawing apparatuses. Because the configurations of the drawing apparatuses 10B to 10J are the same as that of the drawing apparatus 10A, the description will be omitted.

An electron beam emitted from the electron source 11 forms an image on a wafer 14 mounted on a stage 13 through an optical system having an electron lens (not illustrated) and a deflector (not illustrated), and a drawing device 12. The drawing device 12 in response to an instruction from the control unit 15 controls timing of electron beam radiation and the amount of radiation at a predetermined position on the wafer 14. In response to an instruction from a control unit 16 which controls a position of the stage 13, the stage 13 is driven in X, Y, and Z -axis directions.

A main control unit 17 generally controls the control unit 15, the control unit 16, and measurement devices (not illustrated). The main control unit 17 controls the control unit 15 and control unit 16 such that they may be synchronized to form a pattern on the wafer 14. A processing unit 18 has functionality for processing drawing data transmitted from a data server 20, which will be described below, and the control unit 15 generates control data for controlling the drawing device 12. The functionality of the processing unit 18 will be described below. An exposure space of the drawing apparatus 10A is enclosed in a vacuum chamber 19. The inside of the vacuum chamber 19 is evacuated by a vacuum pump (not illustrated).

FIG. 1B illustrates a drawing system 100 and a surrounding configuration according to this exemplary embodiment. The drawing system 100 is surrounded by a generating unit 50, a generating unit 60, and a generating unit 70 which generate data of drawing patterns. These generating unit 50, generating unit 60 and generating unit 70 may be separate information processing units including a CPU and memory (such as a ROM and a RAM) or one information processing unit as far as they or it have or has functions which will be described below. The generating unit 50, generating unit 60 and generating unit 70 may be included in the configuration of the drawing system 100.

The generating unit 50 converts CAD data drawing a pattern desired by a user to vector-format data. In order to generate a vector-format data, the generating unit 50 performs a correction process such as a proximity correction for correcting an influence of forward scattering and back scattering caused when the electron beam is irradiated, a correction relating to resist heating, and a loading effect correction.

The resist heating here refers to a phenomenon in which a resist under a drawing process is heated gradually so that a response characteristic of the resist changes. The loading effect here refers to a phenomenon in which a development mark occurs during a development process due to an influence of a density difference between drawing patterns in regions, which prevents a pattern after an etching process from having a desired shape.

The generating unit 60 renders vector-format data received from the generating unit 50 to convert them to bitmap data represented by multi-gradations of pixels (grayscale value). The generating unit 60 transmits the generated drawing data to a memory 21 and the generating unit 70 within the data server 20. Hereinafter, the data generated by the generating unit 60 will be called common data (identical image data). The common data are data describing an ideal drawing result.

The generating unit 70 generates correction data (correction image data) based on common data acquired from the generating unit 60 and a measurement result, which will be described in detail below. The correction data are data to be used for correcting partial pixels of common data represented by pixels. In other words, the correction data are data to be used for reducing variations in drawing results between drawing apparatuses by bringing each of the drawing results from the drawing apparatuses closer to a predetermined drawing result. The predetermined drawing result here refers to a drawing result (target drawing result) within a predetermined allowable limit of error with respect to an ideal drawing result.

The generating unit 70 stores the correction data in a memory 22. The correction data generated by the generating unit 70 have a sufficiently smaller data amount than that of the common data and may be transmitted in a shorter period of time than the common data. For example, the data amount of the correction data may be equal to or smaller than 1/10 of the common data.

The drawing system 100 includes the drawing apparatuses 10A to 10J and the data server 20 which transmits drawing data such as common data and correction data to the drawing apparatuses 10A to 10J. The drawing system 100 further includes an instructing unit 30 which instructs a method for transmitting drawing data to the data server 20 and a memory 40.

The drawing apparatuses 10A to 10J use data transmitted from a transmitting unit 23 only or from the transmitting unit 23 and a transmitting unit 24 to draw such that drawing results from the ten drawing apparatuses may be brought closer to a predetermined drawing result. The data server 20 has the memory 21, memory 22, transmitting unit 23, and transmitting unit 24. The transmitting unit 23 and the drawing apparatuses 10A to 10J are connected by a network path 25 of Ethernet (registered trademark) or optical fiber. The transmitting unit 24 and the drawing apparatuses 10A to 10J are connected by a network path 25 of Ethernet (registered trademark) or optical fiber.

The transmitting unit 23 and the transmitting unit 24 transmit image data relating to a pattern to be formed on the wafer 14. According to this exemplary embodiment, the transmitting unit 23 transmits common data while the transmitting unit 24 transmits correction data.

The transmitting unit 23 transmits common data within the memory 21 to the drawing apparatus (a plurality of drawing apparatuses) 10A to 10J which draw a target identical pattern. The common data may be transmitted by a broadcast, multicast, or relay method. According to a broadcast method, when the transmitting unit 23 transmits data once, the same data are transmitted to all of the drawing apparatuses 10A to 10J connected to the transmitting unit 23. According to a multicast method, when the transmitting unit 23 transmits data once, the data are transmitted to a plurality of drawing apparatuses designated by the transmitting unit 23 from the drawing apparatuses 10A to 10J connected to the transmitting unit 23.

According to a relay method, one-to-one data exchange is performed in a relay manner. Though the transmitting unit 23 transmits data to one drawing apparatus of the drawing apparatuses 10A to 10J only once, the one drawing apparatus transmits identical data to other drawing apparatuses substantially in parallel with a job for receiving data. While data are being received, the presence of a data loss is checked with a source of the data, and the data are transmitted to other drawing apparatuses after the absence of a data loss is determined. Thus, common data may be transmitted to a plurality of drawing apparatuses with no data loss.

The transmitting unit 24 transmits correction data within the memory 22 based on an instruction from the instructing unit 30. This data transmission is implemented by a unicast method which allows transmission of data to one designated drawing apparatus. Thus, correction data corresponding to each drawing apparatus may be transmitted.

The memory 40 holds information regarding a job process in the drawing apparatuses 10A to 10J and the presence/absence of correction data. In addition, the memory 40 further stores information associating correction data stored within the memory 22 and a drawing apparatus corresponding to the correction data.

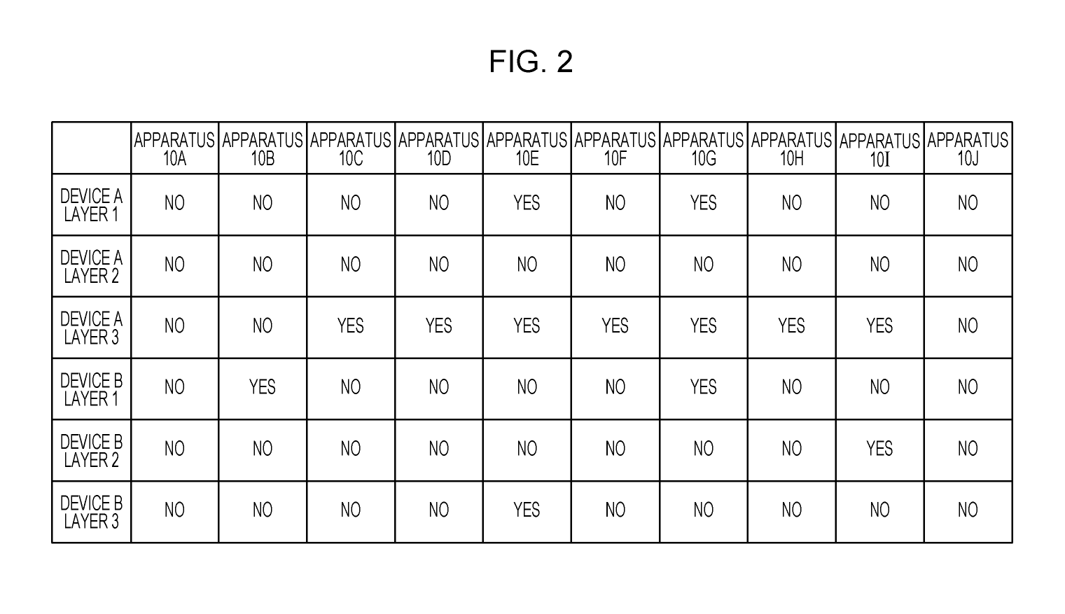

FIG. 2 illustrates data which are an information example regarding a job process in the drawing apparatuses 10A to 10J and the presence/absence of correction data and include a product (device) to be manufactured, a drawing pattern, and the presence/absence of correction data. In FIG. 2, “NO” indicates that a predetermined drawing result is allowed to be acquired from the corresponding drawing apparatus and drawing pattern without transmission of correction data by the transmitting unit 24. “YES” indicates that the transmitting unit 24 is not required to transmit correction data and that partial pixels of common data may be corrected by using correction data to acquire a drawing result close to a drawing result acquired from a drawing apparatus to which correction data have not been transmitted.

For example, in order to form a pattern for a Layer 1 of a device A, correction data are required by the drawing apparatus 10E and drawing apparatus 10G. Based on the information, the instructing unit 30 instructs the transmitting unit 24 to transmit to the drawing apparatus 10E correction data for the drawing apparatus 10E for correcting common data. The instructing unit 30 instructs the transmitting unit 24 to transmit to the drawing apparatus 10G correction data for the drawing apparatus 10G for correcting common data. Thus, in a case where common data for a plurality of drawing apparatuses (at least one drawing apparatus) are to be corrected by using correction data, the transmitting unit 24 transmits correction data corresponding to each of the drawing apparatuses.

Because the drawing system 100 has the ten drawing apparatuses 10A to 10J, drawing processes performed by the ten drawing apparatuses may result in a throughput of 50 to 100 wafers for one hour even though the throughput generated by one apparatus is 5 to 10 wafers for one hour.

A coater/developer (not illustrated) which may coat a resist on the wafer 14 and other apparatus (not illustrated) which performs post processing steps on the wafer 14 after a pattern is drawn are provided internally or externally to the drawing system 100. A common transfer system (not illustrated) which conveys the wafer 14 is further provided. These devices are shared by the ten drawing apparatuses 10A to 10J so that a total area where the apparatuses are disposed within a factory may be reduced and that the configuration between apparatuses may be simplified.

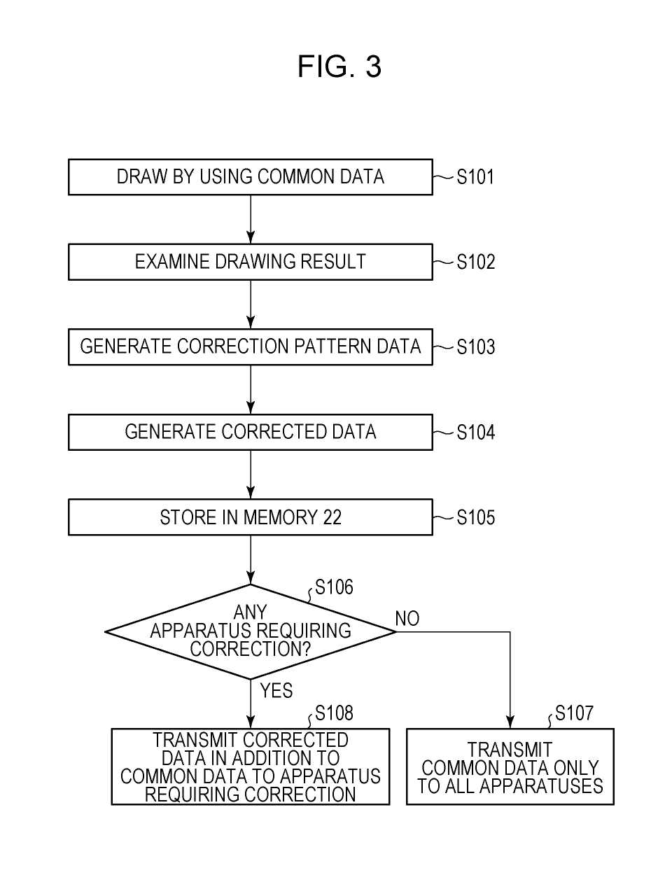

Preprocessing including drawing by using the drawing apparatuses 10A to 10J may require the generating unit 70 to generate correction data. With reference to a flowchart illustrated in FIG. 3, processing up to generation of correction data (S101 to 5105) and correction data transmission processing (S106 to 5108) will be described. Before the generation of correction data, the generating unit 60 generates common data.

First, the transmitting unit 23 reads out common data stored in the memory 21 and transmits common data to all of the drawing apparatuses 10A to 10J to perform a test drawing (S101). Developing a wafer having undergone the test drawing results in a wafer having a resist image pattern. A user may use an optical fault inspection device or one based on a secondary electron detection method (not illustrated) to inspect the presence/absence of a fault in a drawing result (S102). If the fault inspection device detects a fault, a review SEM or a CD-SEM may be used to observe a fault part under a high magnification and check a difference between a target common pattern and the drawing result in detail.

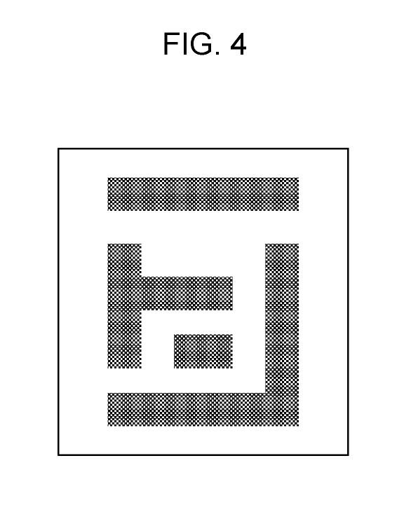

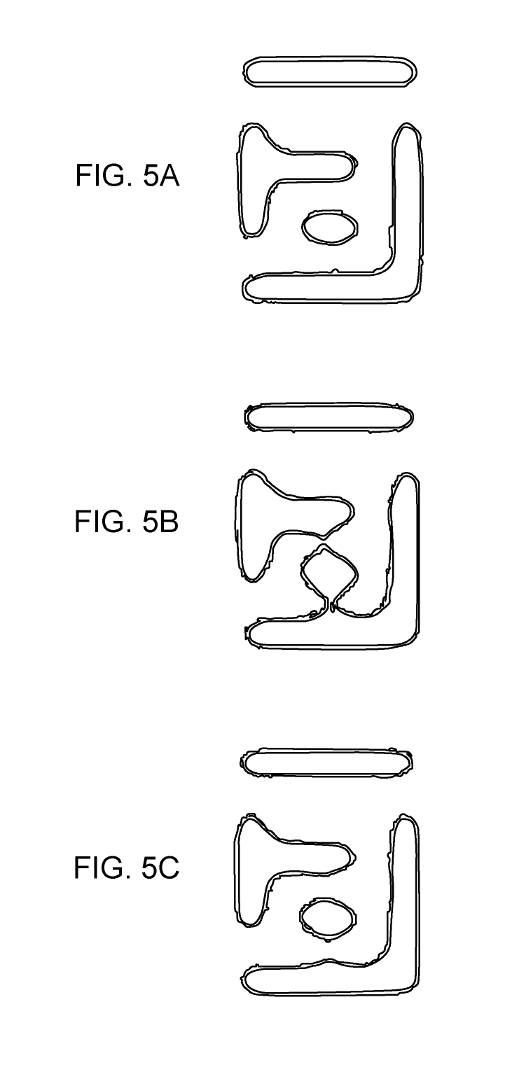

FIG. 4 illustrates common data for test drawing. As examples of drawing results from the drawing apparatuses 10A to 10C, FIG. 5A illustrates a result drawn by the drawing apparatus 10A, FIG. 5B illustrates a result drawn by the drawing apparatus 10B, and FIG. 5C illustrates a result drawing by the drawing apparatus 10C. Apparently, the drawing result illustrated in FIG. 5B has a higher degree of fault to a target pattern than the drawing results in FIG. 5A and FIG. 5C within a predetermined error range.

A user may determine which drawing apparatus needs a correction for bringing a drawing result having a fault closer to a predetermined drawing result by using the drawing results illustrated in those examples.

Referring back to the flowchart in FIG. 3, the generating unit 70 generates correction pattern data which may bring a drawing result from a drawing apparatus determined as needing a correction to a predetermined drawing result based on information on the fault inspection in consideration of a parameter which may be considered as a cause of the fault (S103). Parameter examples which may cause a fault may be a beam diameter, an aberration occurring in an optical system or the like.

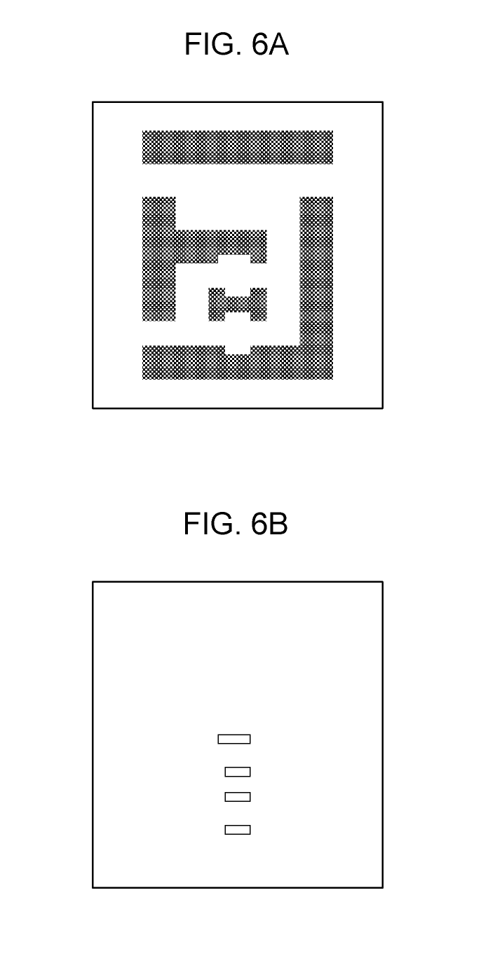

Next, the generating unit 70 generates correction data from a difference between the common data and the correction pattern data (S104) and causes the memory 22 to store the correction data (S105). FIG. 6A illustrates correction pattern data generated from a drawing result from the drawing apparatus 10B, and FIG. 6B illustrates correction data generated from common data and correction pattern data, for example. The correction data may have a smaller data amount than those of the common data and correction pattern data. Thus, the time period required for transmitting the common data and correction pattern data may be shorter than the time period required for transmitting the correction data.

Referring back to the flowchart in FIG. 3, common data transmitted to all of the drawing apparatuses 10A to 10J are stored in the memory 21, and the correction data generated in S105 are stored in the memory 22. The instructing unit 30 determines whether any drawing apparatus needs a correction on the common data by using the table in FIG. 2, for example, before transmitting the drawing data (S106).

If the instructing unit 30 determines that no drawing apparatus requires a correction on the common data (NO), the instructing unit 30 instructs the transmitting unit 23 to transmit the common data to the plurality of drawing apparatuses 10A to 10J by one operation (S107). According to a broadcast method, the transmitting unit 23 transmits the common data once, which means that the common data are transmitted to all of the drawing apparatuses 10A to 10J simultaneously. According to a relay method, the transmitting unit 23 transmits the common data to one of the drawing apparatuses once and finally transmits the common data to all of the drawing apparatuses 10A to 10J substantially at the same time. On the other hand, the instructing unit 30 does not instruct the transmitting unit 24 to transmit the data.

If it is determined that some drawing apparatus needs a correction on the common data (YES), the instructing unit 30 instructs those drawing apparatuses to transmit the correction data in addition to the common data (S108). The instructing unit 30 instructs the transmitting unit 23 to transmit the common data to the plurality of drawing apparatuses 10A to 10J by one operation. On the other hand, the instructing unit 30 instructs the transmitting unit 24 to read out correction data for the drawing apparatus requiring a correction data from the memory 22 and transmit the correction data to the drawing apparatus corresponding to the correction data.

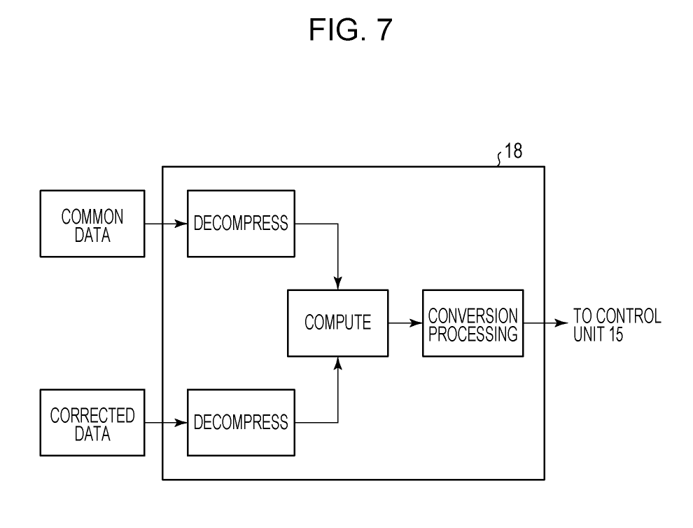

The processing unit 18 in each of the drawing apparatuses uses the common data and correction data received from the transmitting unit 23 and transmitting unit 24 to generate control data for controlling the drawing device 12. FIG. 7 illustrates a flow up to generation of control data.

The processing unit 18 decompresses once the received common data and correction data if they are compressed and performs an arithmetic operation process for reconstructing the correction pattern data. The arithmetic operation process to be performed here synchronizes the common data and the correction data to change the number of gradations of partial pixels of the common data, for example. A distortion correction process in consideration of a distortion of the wafer 14 is performed on the data after the arithmetic operation (after correction). A conversion process including a process for converting to data describing a relationship between a radiation position, timing and a radiated amount is further performed to generate control data to be used by the control unit 15 for controlling the drawing device 12.

If common data are only received, the processing unit 18 performs a distortion correction on the common data and performs a conversion process for converting data on a relationship involving a radiation position and so on to generate the control data. The processing unit 18 transmits the control data generated by using the correction pattern data to the control unit 15. The control unit 15 instructs the drawing device 12 based on the control data to draw a pattern.

A drawing apparatus which may not acquire a target drawing result easily may perform a correction process by using common data and data for a correction to acquire the following two advantages. A first advantage is that a local correction process may be performed on common data for a pattern represented by images of pixels, for example, by using the correction data. Thus, variations in fault degree of drawing results caused by variations in performance of the drawing apparatuses may be reduced, and drawing results may be acquired with higher accuracy than a case where this embodiment is not performed.

A second advantage is that differences between drawing apparatuses may be corrected and, at the same time, the time period required for transmitting data required for the correction may be reduced. Constructing a system which transmits correction pattern data individually corresponding to the drawing apparatuses needing a correction on common data individually to the drawing apparatuses may require the transmitting unit 23 to transmit the data by unicast. However, because the correction pattern data has a large amount of data to an equal degree to that of the common data, the time period may be required until the completion of transmission of drawing data to all of the drawing apparatuses.

On the other hand, according to this exemplary embodiment, the transmission of mass common data by one operation may be allowed, which may reduce the time period required from start of transmission of data to start of drawing. It may further reduce a total capacity required in the memory 21 and memory 22 which store drawing data to be transmitted to the drawing apparatuses 10A to 10J.

In order to generate correction data, a difference may be acquired by subtracting correction pattern data from common data or by subtracting common data from correction pattern data. It may only be required that a synthesis operation performed by the processing unit 18 in a drawing apparatus may finally generate correction pattern data corresponding to the drawing apparatus.

After the generation of correction pattern data (S103), a process may be inserted for performing a test drawing once to check whether a target drawing result may be acquired or not. Correction data may be generated without performing test drawings for all patterns to be formed on the wafer 14. If a cause of a drawing fault in a drawing apparatus is known, correction data may be generated by reflecting the result to other patterns. Thus, the time period required for generating correction data may be reduced.

### EXAMPLES

Next, examples of the first exemplary embodiment will be described. Data of a drawing pattern to be transmitted are data for one chip which is a minimum unit of a repetitive pattern.

In the following examples, the chip size is 10 mm×10 mm, and patterns for six chips are formed in one shot region of 20 mm×30 mm. A minimum grid size of drawing data such as common data and correction data is 5 nm×5 nm, the amount of an electron beam to be radiated to each region has 16 gradations (values), that is, 4 bits. In this case, according to this example, the amount of data for one chip to be generated by the generating unit 60 may be expressed by the following expression (1):

(10 mm/5 nm)²×4 bit÷8 byte/bit=2 TB (1)

Transmitting common data through the network path 25 of a general transmission rate of 10 Gbit/sec may ideally require 2TB×(8 bit/byte)/(10 Gbit/sec)=1600 sec=26 minutes 40 seconds. In other words, a time period equal to 30 minutes or shorter may be required. Transmission of correction pattern data may also require approximately an equal time period.

Next, correction data will also be described. In a case where minimum correction data is considered as 1 μm×1 μm, the data amount required for one correction data set may be expressed by the following expression (2):

(1 μm/5 nm)²×4 bit÷8 byte/bit=20 kB

If 10000 correction data sets are generated, a data amount of 200 MB is required. Therefore, transmission of the data through the 10 Gbit/sec network path 25 may ideally take 0.16 sec.

A first example of the first exemplary embodiment will be described in which the transmitting unit 23 transmits common data to all of the drawing apparatuses 10A to 10J by a broadcast method, and the transmitting unit 24 transmits by a unicast method correction data to a drawing apparatus needing a correction. Because the transmitting unit 23 is capable of transmitting common data to all of the ten drawing apparatuses 10A to 10J by transmitting data by one operation, a total of 30 minutes or shorter may be required for the transmission. Because several seconds may be required for transmission of correction data to many drawing apparatuses requiring correction data if any based on the calculation above, the transmission may require a total of 30 minutes approximately including the time period for transmission of correction data.

A second example of the first exemplary embodiment will be described in which the transmitting unit 23 transmits common data by a relay method and the transmitting unit 24 transmits correction data by a unicast method. In the relay method, whether data to be relayed has a defect or not is checked. Therefore, a longer time period may be required than the transmission in the first example. In a case with an efficiency of 0.7, the time period required for transmission by a broadcast method as described is divided by 0.7. In other words, a time period of 1600 sec/0.7=2286 sec=38 minutes 6 seconds is required. Because the time period required for transmission of correction data may be equal to several seconds, like the first example, a total of 40 minutes may approximately be transmitted.

A comparative example will be described in which the exemplary embodiment is not used, that is, correction pattern data are transmitted to drawing apparatuses by which a desired drawing result is not acquired with common data. For example, correction pattern data are transmitted to eight drawing apparatuses by a unicast method, and common data are transmitted to the remaining two drawing apparatuses by a relay method. Because correction pattern data have substantially an equal data amount of common data, it is assumed that 1600 seconds may be required which may be equal to that for common data from the following calculation.

Because one transmitting unit 23 is capable of transmitting data for one drawing apparatus by a unicast method, the time period required for the transmission may be 2286 sec+1600 sec×8=251 minutes 26 seconds=4 hours 11 minutes 26 seconds, that is, about 4 hours. A memory capacity corresponding to nine common data sets may be required for storing correction pattern data within the data server 20.

From the first, second and comparative examples, the total amount of data to be transmitted from the transmitting unit 23 and transmitting unit 24 may be smaller from a viewpoint of a reduction of the transmission time. The exemplary embodiment may be used in which correction data having a sufficiently smaller data amount than common data are transmitted by a unicast method, instead of transmission of correction pattern data by a unicast method as in the comparative example. Thus, the time period required for the data transmission may sufficiently be reduced. Furthermore, the amount of data held within the data server 20 may be greatly reduced advantageously.

Thus, according to this exemplary embodiment, local correction of common data by using common data and correction data may allow each of drawing apparatuses to draw a pattern close to a desired drawing result. Furthermore, the time period required for transmission of drawing data may be greatly reduced, compared with a case where data having a large data amount, such as correction pattern data, are sequentially transmitted to drawing apparatuses.

### Second Exemplary Embodiment

According to the first exemplary embodiment, the case has been described where all of the ten drawing apparatuses 10A to 10J are used to execute identical processes for identical products. According to a second exemplary embodiment, a case will be described in which different products are to be manufactured by partial drawing apparatuses of drawing apparatuses 10A to 10J by performing different manufacturing processes. The second exemplary embodiment is different from the first exemplary embodiment in that recipe information is stored within the memory 40. The recipe information contains results of previous calculations of how much a total time period for drawing for required product manufacturing may be reduced by transmission of data to which drawing apparatus in which time zone.

According to the second exemplary embodiment, a device A is manufactured by using the drawing apparatuses 10A to 10E, and a device B is manufactured by using the drawing apparatuses 10F to 10J. Unlike the first exemplary embodiment, it may be defined such that different products may be handled by different drawing apparatuses.

Also in a case where different products are manufactured in combination, common data for the drawing apparatuses to handle an identical product and identical processes are transmitted by one operation, and correction data are transmitted by a unicast method to a drawing apparatus needing a correction on the correction pattern data. Because the correction data have a smaller data amount than the common data, the data amount within the data server 20 may be reduced. Furthermore, the time period required for transmitting data may be shorter than a case where correction pattern data are transmitted to each of the drawing apparatuses.

Because the data amount for a required pattern and the transmission time required for the pattern may differ between different products, data may be transmitted to the drawing apparatuses 10F to 10J during processes performed by the drawing apparatuses 10A to 10E. Thus, wasteful time periods, such as a time period when all drawing apparatuses are stopping for data reception and a time period when the data server 20 is stopping while the drawing apparatuses 10A to 10J are drawing, may be reduced, and the operating rate of the entire drawing system 100 may be increased.

Other exemplary embodiments will be described. While the drawing apparatuses 10A to 10J in the drawing system 100 are performing pattern drawing, memory for storing data needed for the next pattern may be prepared. In this case, a large data amount thereof may possibly contribute to an increase of an area of a space where a memory device therefor is to be installed. In one or more embodiments that may not use an increased area for memory device installation, the transmitting unit 23 and transmitting unit 24 may transmit data in a period from the completion of drawing of one type of pattern (first pattern) to start of drawing of another type of pattern (second pattern) in a plurality of apparatuses which draw an identical target pattern among the drawing apparatuses 10A to 10J.

However, if the data amount of correction data to be handled by the transmitting unit 24 is appropriate for allowing storage within the corresponding drawing apparatus, the correction data may be transmitted in advance and be stored within the drawing apparatus before a plurality of types of pattern are drawn.

In a case where the entire drawing system 100 may produce a throughput of 100 wafers per hour, a pattern is drawn by ten drawing apparatuses on a wafer for four lots at a maximum. In other words, data transmission may possibly be performed at a maximum of 4 times. So, shorter time may be desirable for the data transmission. From these reasons, at least one drawing system of the present inventions could be used to draw a complicated pattern such as a pattern of a logic circuit which may require a correction and a switch of drawn pattern.

A transmitting unit may be integrated, as far as to have at least functionality of the transmitting unit 23, transmitting unit 24 and instructing unit 30. The transmitting units 23 and 24 may compress data as required and then transmit data. The memories 21 and 22 may be configured as identical memories.

The common data and correction data as described above may be data handling an image such as vector-format data and bitmap format data. In particular, data converted to bitmap format data in advance may be transmitted in a greatly reduced transmission time.

The drawing system 100 could provide same effect as described above in a case where correction data are required in all drawing apparatuses within the drawing system 100. In a case where a target drawing result and an image represented by common data are widely different, the data amount of correction data required for all drawing apparatuses is small. Thus, the time for data transmission may be reduced, and the necessary memory capacity may be reduced. Furthermore, common data and correction data may be used to correct a part of the common data for bringing closer to a predetermined drawing result. Thus, variations in drawing result between drawing apparatuses may be reduced.

### Article Manufacturing Method

At least one method for manufacturing an article (such as a semiconductor integrated circuit element, a liquid crystal display device, a CD-RW, and a photo mask, for example) according to the present inventions includes a process for drawing a pattern by using the drawing system and a process for developing a substrate such as a wafer and a glass on which a pattern is drawn. The at least one method may further include other publicly known processes (such as oxidation, film formation, vapor deposition, doping, flattening, resist separation, dicing, bonding, and packaging).

While the present inventions have been described with reference to exemplary embodiments, it is to be understood that the inventions are not limited to the disclosed exemplary embodiments. The scope of the following claims is to be accorded the broadest interpretation so as to encompass all such modifications and equivalent structures and functions.

This application claims the benefit of Japanese Patent Application No. 2014-069414, filed Mar. 28, 2014, which is hereby incorporated by reference herein in its entirety.

What is claimed is:

1. A drawing system comprising:
drawing apparatuses each configured to radiate a beam onto a substrate to draw a pattern; and
a transmitting unit configured to transmit image data regarding the pattern to the drawing apparatuses,
wherein the transmitting unit is configured to transmit identical image data to a plurality of drawing apparatuses included in the drawing apparatuses; and
at least one drawing apparatus of the plurality of drawing apparatuses is configured to use the identical image data and correction image data for correcting a partial image of the identical image data to correct the partial image.

2. The drawing system according to claim 1, wherein the at least one drawing apparatus is configured to correct the partial image such that a drawing result from the at least one drawing apparatus is brought closer to a predetermined drawing result.

3. The drawing system according to claim 1, wherein the identical image data are image data regarding a predetermined drawing result.

4. The drawing system according to claim 1, wherein the transmitting unit is configured to transmit the identical image data to the plurality of drawing apparatuses by one operation.

5. The drawing system according to claim 1, wherein the identical image data and the correction image data are bitmap-format data.

6. The drawing system according to claim 5, wherein the at least one drawing apparatus is configured to synthesize the identical image data and the correction image data to change the number of gradations of pixels of the partial image.

7. The drawing system according to claim 1, wherein the transmitting unit is configured to transmit the identical image data to the plurality of drawing apparatuses during a period since the plurality of drawing apparatuses completes drawing of a first pattern until drawing of a second pattern is started.

8. The drawing system according to claim 1, wherein the transmitting unit is configured to transmit to at least two drawing apparatuses of the plurality of drawing apparatuses correction image data corresponding to each of the drawing apparatuses.

9. The drawing system according to claim 8, wherein a data amount of the correction image data is equal to or smaller than 1/10 of the data amount of the identical drawing data.

10. The drawing system according to claim 8, wherein the transmitting unit is configured to transmit the correction image data based on information regarding a job process in the drawing apparatuses and a presence or absence of the correction image data.

11. A drawing method comprising:
transmitting identical image data regarding a pattern to a plurality of drawing apparatuses included in drawing apparatuses each of which are configured to radiate a beam onto a substrate to draw the pattern;
using the identical image data and correction image data for correcting a partial image of the identical image data to correct a part of the identical image data by using at least one drawing apparatus of the plurality of drawing apparatuses; and
drawing the pattern by using the at least one drawing apparatus based on the corrected image data.

12. An article manufacturing method comprising:
drawing a pattern onto a substrate by a drawing system; and
developing the substrate on which the pattern is drawn, wherein the drawing system includes:
drawing apparatuses each configured to radiate a beam onto a substrate to draw a pattern; and
a transmitting unit configured to transmit image data regarding the pattern to the drawing apparatuses;
wherein the transmitting unit is configured to transmit identical image data to a plurality of drawing apparatuses included in the drawing apparatuses; and
at least one drawing apparatus of the plurality of drawing apparatuses is configured to use the identical image data and correction image data for correcting a partial image of the identical image data to correct the partial image.
